(19) United States
(12) Patent Application Publication
(10) Pub. No.: US 2011/0069608 A1
(43) Pub. Date: Mar. 24, 2011

(54) System for providing backup programming at radio or television transmitter

(76) Inventors: Gary M. Miller, Kearneysville, WV (US); Winston M. Gadsby, Herndon, VA (US)

(21) Appl. No.: 12/585,707

(22) Filed: Sep. 22, 2009

(51) Int. Cl. H04L 1/08; H04N 11/02; H04N 7/173

(52) U.S. Cl. 370/218; 370/216; 375/240.01; 725/115; 370/242; 725/118; 375/E07.026

(57) ABSTRACT

A system transmits backup programming media in a transmitter station being connected to a remote media station. The media station includes a media programming input to receive a source media signal, which includes media programming. The media station further includes an Ethernet programming input that receives an Ethernet media signal including backup media programming being different the media programming. A transmitter station receives the source media signal via a transmission medium and transmits the media programming. The transmitter station further receives the Ethernet media signal and stores the backup media programming in a storage device. A controller detects a fault on a transmission medium connecting the media station and the transmitting station. The controller retrieves the stored backup media programming and generates a backup media signal. A transmitter transmits the backup media programming based on the backup media signal until it is controlled to re-transmit the source media signal.

### FIELD OF THE INVENTION

The present application relates generally to a media transmission system and, more particularly, to a transmitter system providing back-up media programming for a radio and/or television transmission system.

### BACKGROUND OF THE INVENTION

Transmission systems such as radio or television broadcast stations are widely used to transmit media programming, such as radio and/or television programs, to a large number of listeners and/or viewers. Traditional transmission systems such as broadcast stations include a studio connected to a transmission station via a transmission medium. The studio controls the programming media to be transmitted. More specifically, media programming is selected and is processed to generate a media signal that is delivered over the transmission medium to the transmission station. The transmission station receives the media signal and ultimately transmits the program media to the listeners/and or viewers such as by wireless broadcasting in the frequency bands designated for AM, FM, television (e.g., UHF and VHF) or satellite transmissions.

Many radio and television broadcast stations do not have their actual transmission station (e.g., a transmitter and broadcast tower) located on the same property as their programming studio. In fact, many broadcast stations share a single transmission station. For example, many radio and television broadcast stations comprise a studio that is located 10, 15 and sometimes as many as 30 miles away from the actual transmitter and tower. Some radio and television stations employ a microwave relay tower. A program signal to be broadcast via the remote tower is sent by microwave from the site of the studio to a similar microwave receptor on the grounds where the transmitter and tower are located. The transmitted microwave signal is then converted into a signal that can be broadcast to the general public, for example. Thus, the transmission medium is a microwave or other wireless link or a wired link (e.g., a T1, ISDN and/or other links) configured to effectively span geographic distances between the studio and the transmission station.

Since the transmission station is located remotely from the studio, however, a transmission failure between the studio and the transmission station can cause disruptions in the media programming received by the listeners and/or viewers. Further, a transmission failure between the studio and the transmission station may not be detected immediately. As a result, listeners and/or viewers may experience media disruption for an indefinite amount of time.

A need therefore exists for more reliable transmission of signals between a studio and transmitter of a broadcast station.

### SUMMARY OF THE INVENTION

As noted above, exemplary embodiments of the present invention address at least the above problems and/or disadvantages, and provide at least the advantages described below.

In accordance with an exemplary embodiment of the present invention, a media transmission system is provided for selectively transmitting backup programming media in which a transmitter station is connected to a remote media station via a transmission medium. The media transmission system generates a source media signal including media programming via a media programming source located at the media station; generates an Ethernet media signal including backup media programming via an Ethernet programming source located a the media station; receives the source media signal at the transmitter station and transmits the media programming based on the source media signal; receives the Ethernet media signal at the transmitter station and stores the backup media programming in a storage device based on the Ethernet media signal; detects a fault on the transmission medium, or is otherwise instructed to switch to transmission of stored backup media programming; retrieves the stored backup media programming and generates a backup media signal including the backup media programming; and transmits backup media programming based on the backup media signal.

Another exemplary embodiment of the present invention provides for storing the backup media programming while simultaneously transmitting the source media signal.

Another exemplary embodiment of the present invention provides for multiplexing the source media signal and the Ethernet media signal for outputting a data signal to the transmitter station.

Still another exemplary embodiment of the present invention provides for demultiplexing the data signal received by the transmitter station for obtaining the source media signal and the Ethernet media signal.

Still another exemplary embodiment of the present invention provides for compressing the source media signal prior to multiplexing the source media signal with the Ethernet media signal.

Another exemplary embodiment of the present invention provides for decompressing the source media signal after de-multiplexing the data signal.

Yet another exemplary embodiment of the present invention provides for detecting a fault on the transmission medium based on Cyclic Redundancy Check (CRC) bits included with the data signal.

Still another exemplary embodiment of the present invention provides for the backup media programming being different than the media programming.

### BRIEF DESCRIPTION OF THE DRAWINGS

The above and other exemplary features, aspects and advantages of the present invention will become more apparent from the following detailed description of certain exemplary embodiments thereof when taken in conjunction with the accompanying drawings in which:

FIG. 1 is a schematic block diagram of a media transmission system according to an exemplary embodiment of the present invention;

FIG. 2 is a flow diagram of an illustrative method for transmitting backup media programming in a media transmission system according to an exemplary embodiment of the present invention;

FIG. 3 is a schematic block diagram of a media transmission system according to an alternative exemplary embodiment of the present invention;

FIG. 4 is a schematic block diagram a video transmission system including a media station, a transmitter station and a transmission medium for transmitting video media programming according to an exemplary embodiment of the present invention;

FIG. 5 is a schematic block diagram of a digital FM media station according to an exemplary embodiment of the present invention;

FIG. 6. is a schematic block diagram of a digital FM transmitter station according to an exemplary embodiment of the present invention;

FIG. 7. is a schematic block diagram of an AM media station according to an exemplary embodiment of the present invention;

FIG. 8 is a schematic block diagram of an AM transmitter station according to an exemplary embodiment of the present invention;

FIG. 9 is a schematic block diagram of a media transmission system according to an alternative exemplary embodiment of the present invention; and

FIG. 10 is a schematic block diagram of a media transmission system including dual media stations and a single transmitter station according to an exemplary embodiment of the present invention.

### DETAILED DESCRIPTION OF EXEMPLARY EMBODIMENTS

A media transmission system transports high quality audio and/or video media programming from a media station to a transmitter station via a transmission medium. In the event of a transmission medium or equipment failure, there is no media transmission. A common problem, which is addressed by exemplary embodiments of the present invention, is how to quickly recover media transmission in the event the transmission medium or other equipment fails.

As described below, a media transmission system constructed in accordance with exemplary embodiments of the present invention comprises a non-volatile storage device. Once the media transmission system detects a loss of communication with the media station, backup media programming stored in the storage device can be played to avoid dead air time. The backup media programming may be stored as computer files. Accordingly, a number of files may be linked together and played in series and then looped to the beginning of the series. Once communication to the media station is resolved, the media transmission system can again transmit the media programming. Further, users can operate the media transmission system to selectively switch alternative programming on and off as desired without the necessity of a faulty transmission medium or equipment failure (e.g., to transmit emergency broadcast messages).

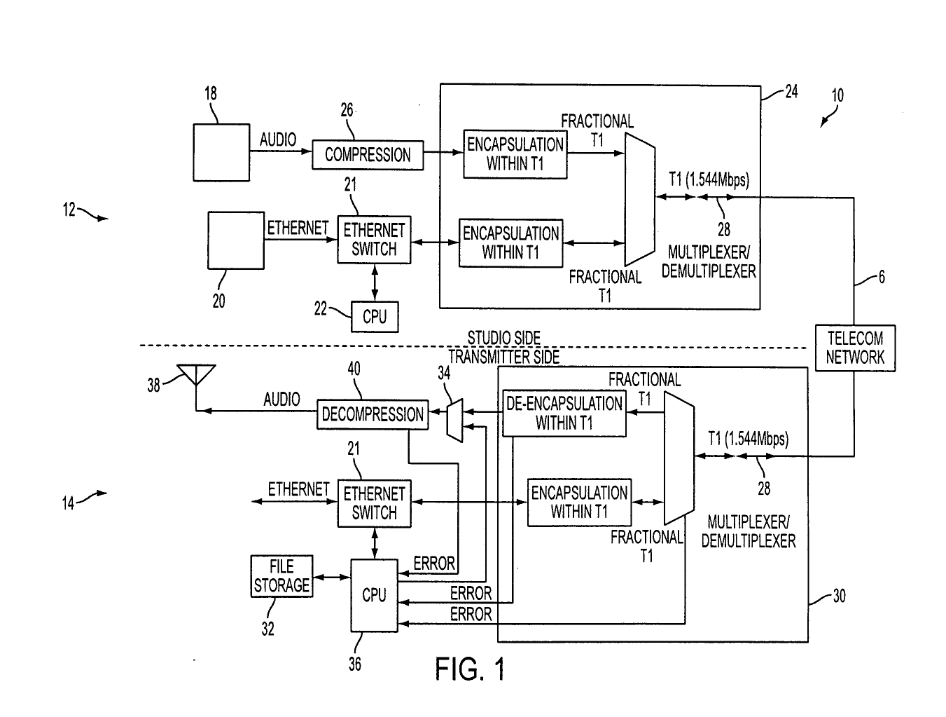

Referring to the Figures, wherein like numerals indicate corresponding parts throughout the several views, FIG. 1 generally shows a media transmission system 10 including a media station 12, a transmitter station 14, and a transmission medium 16. The media station 12 selects and processes media programming. The transmitter station 14 is located remotely from the media station 12 and ultimately transmits the media programming provided by the media station 12 in real-time.

The transmission medium 16 connects the media station 12 with the transmitter station 14 for communicating signals and/or data therebetween. The transmission medium 16 is a telecom network that can comprise, but is not limited to, E1 and/or T1, or T3 transmission media, Ethernet, a radio link, free air optics, SONET, among other transmission links and modalities. The data communicated between the media station 12 and the transmitter station 14 includes, but is not limited to, digital and/or analog audio signals, digital and/or analog video signals, Ethernet data packets, Cyclic Redundancy Check (CRC) bits, address resolution protocol (ARP) data, and Operation, Administration and Maintenance (OAM) data. Further, the data delivered over the transmission medium 16 may comprise compressed and/or decompressed digital data.

The media station 12 comprises at least one media programming source 18 for generating a source media signal including media programming, an Ethernet media source 20 including one or more inputs or ports for receiving signals from a media programming source, a station controller 22, and a station network module 24. The media programming source 18 may comprise a traditional analog media programming source, a traditional digital media source, or a High Definition (HD) digital media source that generates an HD digital media signal. Further, the programming media provided by the traditional media sources may be different than the programming media provided by the HD digital media source.

Various audio processing modules such as a compression module 26 may also be included with the media station 12. The compression module 26 compresses the source media signal and outputs a compressed source media signal. Additionally, the compression module 26 may comprise one or more sample rate converters for adjusting the sampling and/or data rate of a HD digital programming media to allow synchronization with the transmission medium 16. Changing the data rate allows the digital audio interface to run at a different speed and/or with a different source from the transmission rate of data communicated over the transmission medium 16. For example, the available rates for audio carried over a transmission medium 16 such as a T1/E1 interface include, but are not limited, to 48 K and 32 K samples per second. In addition, the station network module 24 and the transmission network module 30 can handle incoming audio at rates including, but not limited to, 48 K, 44.1 K and 32 K samples per second. For incoming audio samples received at 44.1 K, the audio may be converted to 48 K samples per second by default.

The Ethernet media source 20 includes an Ethernet media source input. The Ethernet media source 20 provides backup media programming, and generates an Ethernet media signal that comprises backup media programming. The backup media programming may be different than media programming generated by the media programming source 18. The transmission of the backup media programming is described in greater detail below. Additionally, an Ethernet switch 21 may be included with each of the media station 12 and transmitter station 14 for routing data to various corresponding modules.

The station controller 22 is in electrical communication with the Ethernet media input for outputting at least one user selection signal for selecting transmission of either the media programming source 18 or a backup media source included with the transmitter station 14, as described in greater detail below. In addition, the station controller 22 may output public alert messages and/or other various alerts.

The station network module 24 is in electrical communication with the media programming source 18 and the Ethernet media source 20 for further processing the source media signal, the Ethernet media signal, and/or the HD digital media signal. Specifically, the station network module 24 multiplexes the source media signal, the Ethernet media signal, and/or the HD digital media signal to generate a single data signal 28. The data signal 28 is then delivered to the transmission medium 16. The station network module 24 may further encapsulate the source media signal, the Ethernet media signal, and/or the HD digital media signal prior to generating the data signal.

The transmitter station 14 comprises a transmitter network module 30, storage device 32, a selection module 34, a controller 36, and a transmitter 38. The transmitter network module 30 is included with the remotely located transmitter station 14 for receiving the data signal 28. The transmitter network module 30 demultiplexes the data signal to obtain the source media signal, the Ethernet signal, and/or the HD digital media signal. Further, the transmitter network module 30 may de-encapsulate the source media signal, the Ethernet signal and/or the HD digital media signal if the media signal, the Ethernet signal, and/or the HD digital media signal are encapsulated. Similar to the media station 12, the transmitter station 14 may comprise various processing modules, such as a decompression module 40 for decompressing a compressed the source media signal to obtain the source media signal.

The storage device 32 is in electrical communication with the transmitter network module 30 for storing backup media programming. As discussed above, the media station 12 comprises an Ethernet media source 20 that generates an Ethernet media signal including backup media programming. The transmitter network module 30 obtains the Ethernet media signal after demultiplexing the data signal 28. After demultiplexing the data signal 28, the transmitter network module 30 delivers the Ethernet media signal to the storage device 32 for storing the backup media programming. As mentioned above, the backup media programming may be different than the media programming to be transmitted by the transmitter station 14 during real-time.

The selection module 34 is selectively operable in a source mode for delivering the source media signal to the transmitter 38 for transmitting the media programming to listeners and/or viewers in real-time. Further, the selection module 34 is selectively operable in a backup mode for delivering a backup signal to the transmitter 38 for transmitting the backup media programming to listeners and/or viewers, as discussed in greater detail below. As previously mentioned, the media station 12 may include a station controller 22 in electrical communication with the Ethernet media input for outputting at least one user selection signal. Accordingly, the selection module 34 can be controlled by a user of the station controller 22 located at the media station 12 for selecting one of the source mode or the backup mode of the selection module 34. The selection module 34 may include a lighting protection system and drop-out relays to quickly switch over to the backup mode if the transmission of backup media programming is required. It can be appreciated that an additional selection module, i.e., a backup selection module 30′ may be included which operates in case the selection module fails. The backup selection module 30′ operates in same manner as the selection module for delivering either the source media signal or the backup signal to the transmitter 38.

The controller 36 is in electrical communication with the transmitter network module 30, the storage device 32, and the selection module 34. The controller 36 receives at least one of the source media signal, Ethernet media signal, and/or HD digital media signal from the transmitter network module. The source media signal may be delivered to the controller 36 prior to de-encapsulation, after de-encapsulation, and/or after de-compression. In addition, the controller 36 may determine whether the data transmission between the media station 12 and the transmitter station 14 is faulty. A faulty data transmission comprises, but is not limited to, the station network module 24 becoming disabled, a corrupt data signal, an incorrectly de-encapsulated source media signal, and/or incorrectly decompressed source media signal. As mentioned earlier, the data delivered over the transmission medium 16 may comprise CRC bits. Accordingly, the error in the data signal may be determined using a Cyclic Redundancy Check to analyze the CRC bits.

When the controller 36 determines that the transmission medium 16 is functional i.e., is not faulty, the media programming is preferably transmitted in real-time while the storage device 32 is simultaneously stored with the backup media programming provided by the remotely located Ethernet media source 20. Accordingly, the storage device 32 can be constantly loaded with backup media programming. If the transmission medium 16 is determined to be faulty, or a user selects transmission of the backup media programming via the station controller 22, the controller 36 selects the backup mode of the selection module 34 for transmitting backup programming media to listeners and/or viewers. More specifically, after selecting the backup mode, the controller 36 retrieves the backup media programming from the storage device 32 and generates a backup media signal including the backup media programming. In response to operating in the backup mode, the selection module 34 receives the backup media signal from the controller 36 and delivers the backup media signal to the transmitter 38. Upon receiving the backup media signal, the transmitter 38 transmits the backup media programming to listeners and/or viewers in place of the media programming.

Accordingly, disruption of media transmission to the listeners and/or viewers may be prevented even when a complete disconnection between the media station 12 and the transmitter station 14 occurs. Furthermore, a more accurate determination of a faulty transmission medium is achieved since faulty detection may be based on actual errors in the data signal, as opposed to analyzing the audio signal to determine silence and/or lapses in audio transmission.

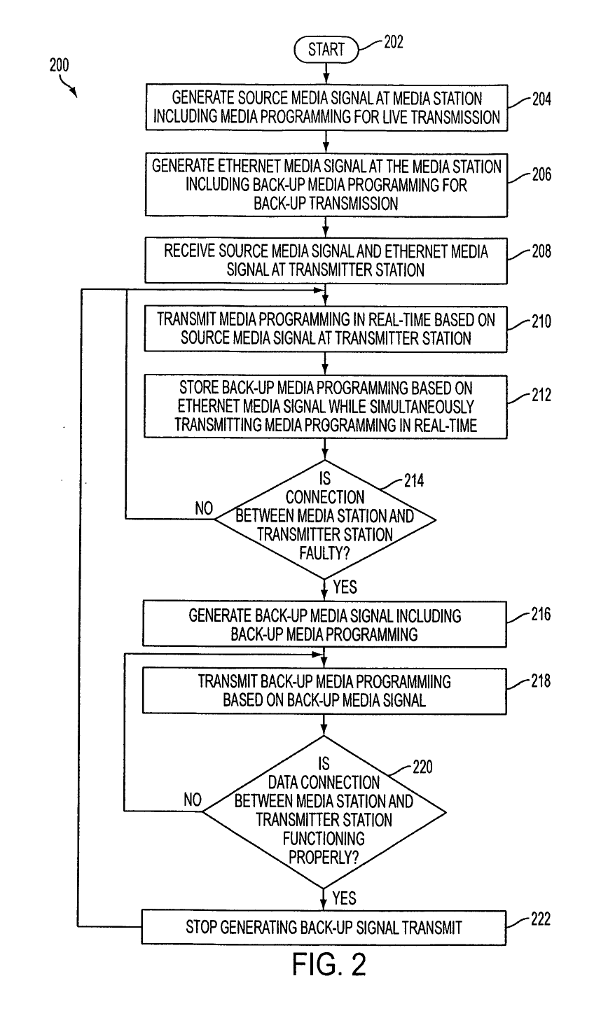

Referring now to FIG. 2, the media transmission system 10 implements a method generally shown at 200 to transmit backup media programming in accordance with an exemplary embodiment of the present invention. The method starts at step 202 and proceeds to step 204 during which the media programming source 18 located at a media station 12 generates a source media signal including media programming to be transmitted in real-time, i.e. live. In step 206, the Ethernet programming source 20 located at the media station 12 generates an Ethernet media signal including backup media programming for backup transmission. The transmitter station 14 receives both the source media signal and the Ethernet media signal in step 208. In step 210, a transmitter 38 included with the transmitter station 14 transmits the media programming in real-time based on the source media signal. In step 212, the Ethernet media signal is delivered to a storage device 32 and the backup media programming is stored therein, preferably while simultaneously transmitting the media programming in real-time.

The controller 36 determines whether the data connection between the media station 12 and the transmitter station 14 is faulty, or a user has selected alternate programming, in step 214. If the data connection is not faulty, the method returns to step 210 and continues to transmit the media programming. If a faulty data connection, or a user's selection of alternate programming, is detected in step 214, then the controller 36 generates a backup signal in step 216. For example, if the transmission medium 16 or link (e.g., a T1 line) is broken or disrupted, or if the media station 12 becomes inoperable, an error at the transmission medium 16 or an error in the de-encapsulation or an error in the decompression would be detected and reported to the controller 36. The backup signal comprises the backup media programming stored in the storage device 32. In step 218, the transmitter 38 receives the backup media signal and transmits the backup media programming. In step 220, the controller 36 determines whether the data connection between the media station 12 and transmitter station 14 has been restored and is functioning properly or a user requests cessation of the backup programming media transmission. If the data connection is functioning properly, the controller 36 stops generating the backup signal in step 222 and the method returns to step 210 to transmit the media programming. If the data connection is not yet functioning properly, the method returns to step 218 and the transmitter 38 continues to transmit the backup programming media.

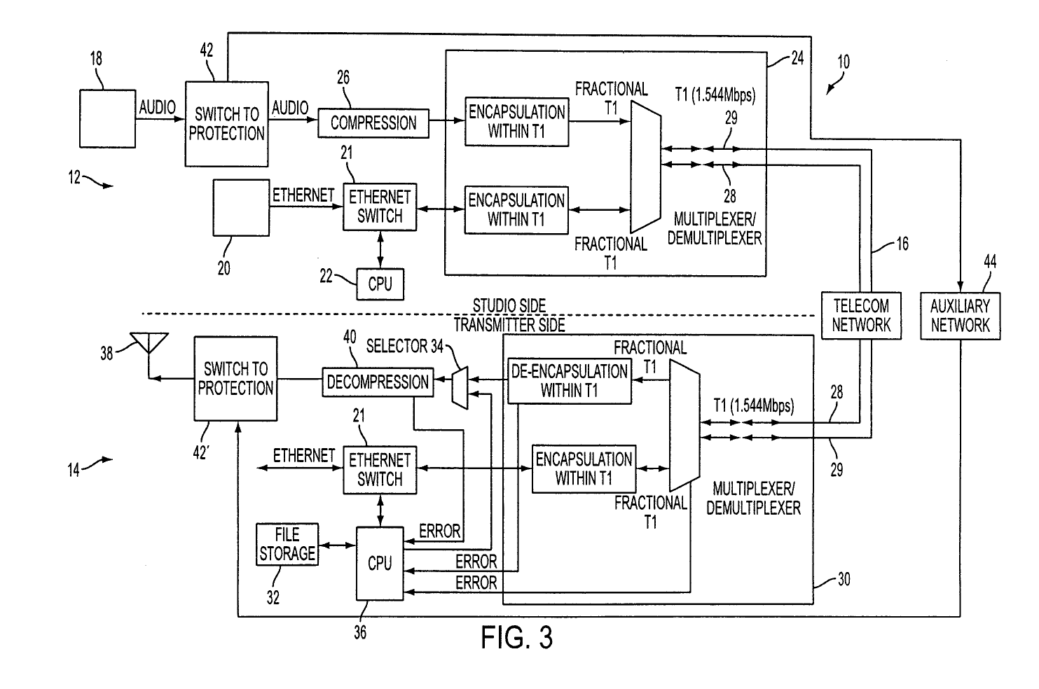

Referring now to FIG. 3, an alternative exemplary embodiment of the media transmission system 10 is generally shown. The media transmission system 10 operates similar to media transmission system 10 of FIG. 1, which is described in detail above. The media transmission system 10 includes a redundant transmission medium 16 comprising a primary transmission line 28 and a secondary transmission line 29. The primary transmission line 28 communicates the data signal including the source media programming, similar to the transmission medium 16 described above. The secondary transmission line 29 communicates a redundant data signal between the station network module 24 and the transmitter network module 30. The redundant data signal is identical to the data signal communicated over the primary transmission line 28 and is used to communicate data from the source media signal to transmitter network module 30 in case the primary transmission line 28 fails. Specifically, the transmitter network module 30 selectably receives the data signal on the primary transmission line 28 and redundant data signal on the secondary transmission line 29. Further, the transmitter network module 30 analyzes the CRC packets included with the data signal on line 28 and the redundant data signal on line 29. Based on the CRC analysis, the transmitter network module 30 determines whether the primary data signal on line 28 is of higher quality than the redundant data signal on line 29. When the primary transmission line 28 fails, or when the transmission quality of the redundant data signal on line 29 exceeds that of the data signal on line 28, the transmitter network module 30 may select the secondary transmission line 29 to receive the redundant data signal. Accordingly, communication of the source media signal between the station network module 24 and the transmitter network module 30 can be sustained even though the primary transmission line 28 fails.

The media transmission system 10 further includes switch-to-protect modules 42, 42′ and an auxiliary transmission medium 44. A first switch-to-protect module 42 is included in the media station 12 and is connected between the media programming source 18 and the compression module 26. A second switch-to-protect module 42′ is included in the transmitter station 14 and is connected between the decompression module 28 and the transmitter 38. The auxiliary transmission medium 44 is connected between switch-to-protect modules 42, 42′. The auxiliary transmission network 44 may include an auxiliary network module similar to the station and transmitter network modules 24, 30, a microwave data link, a spare copper line pair, or any other transport system that connects the media station 12 and the transmitter station 14 during failure. In this way, the analog audio data completely bypasses the transmission medium 16 to restore a complete media path. If the auxiliary transmission medium 44 is not configured or desired, and the network or the station network module 24 and/or the transmitter network module 30 fail, the final level of protection is that backup media programming is transmitted by the transmitter 38, as described in greater detail below.

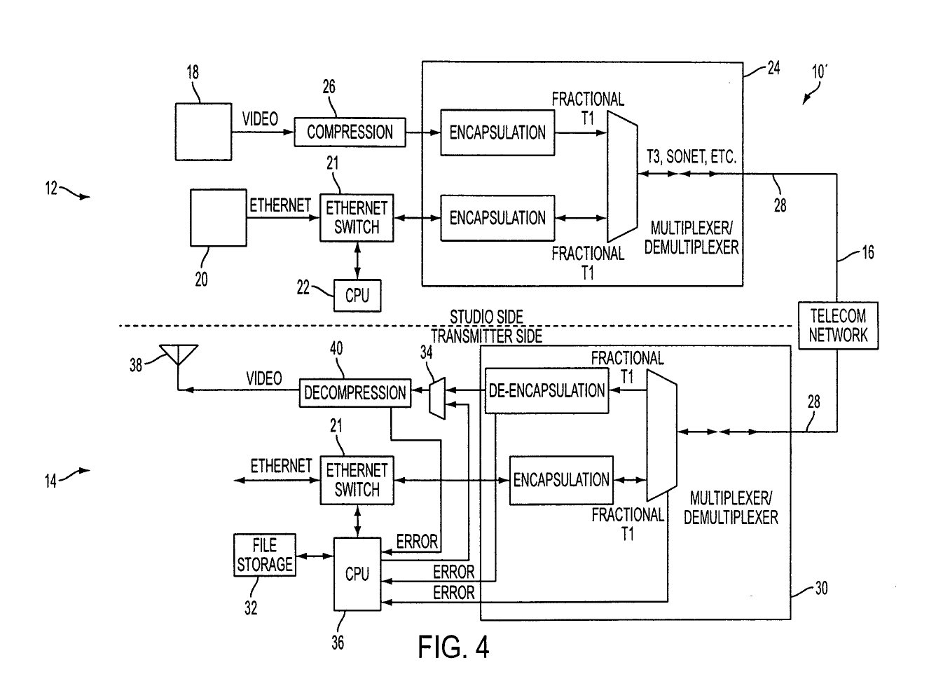

The switch-to-protect modules 42, 42′ operate to select the auxiliary transmission medium 44 to provide an auxiliary data path for delivering the source media signal to the transmitter 38 if both the primary and secondary transmission lines 28, 29 fail. Although FIG. 4 shows a first switch-to-protect module 42 included with the media station 12 and a second switch-to-protect module 42′ included with the transmitter station 14, it can be appreciated that only one switch-to-protect module 42 may be used with either the media station 12 or the transmitter station 14.

More specifically, the switch-to-protect modules 42, 42′ include drop-out relays (not shown) operable in a normal position and an auxiliary position. While operating in the normal position, the drop-out relays included with the first switch-to-protect module 42 provide a circuit path between the media programming source 18 and the compression module 26, and the drop-out relays included in the second switch-to-protect module 42′ provide a circuit path between the decompression module 40 and the transmitter 38. Accordingly, the primary data signal is communicated from the media station 12 to the transmitter station 14 via the redundant transmission medium 16. However, if the station network module 24 and/or the transmitter network module 30 detects that both the primary and secondary transmission lines 28, 29 have failed, a drop-out relay control signal is output to each of the first and second switch-to-protect modules 42, 42′ to induce the auxiliary position of the drop-out relays. In addition, if station network module 24 and/or the transmission network module 30 never powers on or a processor or other failure of the station network module 24 and/or transmitter network module 30 occurs, the first and second switch-to-protect modules 42, 42′ may be selected to operate in the auxiliary position by default.

While operating in the auxiliary position, the drop-out relays included with the first and second switch-to-protect modules 42, 42′ select the auxiliary transmission medium 44. Accordingly, the source media signal is communicated from the media station 12 to the transmitter station 14 via the auxiliary transmission medium 44 even though both the primary transmission line 28 and the secondary transmission line 29 of the redundant transmission medium 16 are faulty.

Accordingly, at least one exemplary embodiment of the present invention provides several levels of transmission fault protection. For example, at least one exemplary embodiment of the invention provides a primary transmission line 28 and a secondary transmission line 29 with very robust circuit protection, so that hardware failures are limited. If the primary line 28 fails, a secondary transmission line 29 is selected to communicate the redundant data signal for transmitting the source media.

If both the primary transmission line 28 and the secondary transmission line 29, or the station network module 24 and/or the transmitter network module 30 fail, the auxiliary position of the drop-out relays are induced to select the auxiliary transmission medium 44, which provides an alternative transmission link for communicating the media station 12 with the transmitter station 14. Finally, if the auxiliary transmission medium 44 fails or is unavailable, the backup media programming is retrieved from the storage device 32 and is transmitted.

Lightning protection (not shown) may also be included with the transmission lines 28, 29. For example, one or more fuses may be wired in series with each transmission line 28,29, and a protector device may be wired from each transmission line 28,29 to ground so that if a significant lightning transient is coupled to the transmission medium 16, the protector device clamps the transient to ground. If the transient goes beyond the current carrying ability of the clamping device, the fuse opens up, protecting the media transmission system 10 from further damage. In addition, a circuit board may be designed so that the traces can handle the extra current present during a normal lightning strike.

As discussed above, a primary transmission line 28 and a secondary transmission line 29 may be included to provide redundancy i.e., redundant transmission of the media programming. One of the two transmission lines 28, 29 may be used to transmit the data from the media station 12 to the transmitter station 14. Both the primary transmission line 28 and the secondary transmission line 29 are active and configured in a typical installation. As discussed above, both lines 28, 29 preferably carry the same media programming. The transmitter network module 30 receives and decodes information from the primary transmission line 28 when the primary transmission line 28 is functional and selected.

The transmitter network module 30 simultaneously monitors the transmission quality of both transmission lines 28, 29 by analyzing a CRC value that is periodically encoded into the data stream communicated by each transmission line 28, 29. The CRC value preferably matches a calculation determined from the other bits in the transmission lines 28, 29. Short errors in the CRC calculation are ignored. However, if the error condition persists, the transmitter network module 30 determines a line failure on the selected transmission line 28, 29. As long as the primary transmission line 28 has acceptable quality, the transmitter network module 30 continues routing data through the primary transmission line 28. However, if the CRC calculation of the primary transmission line 28 is not correct for a sufficient duration, the transmitter network module 30 selects the secondary transmission line 29 and continues operating normally, assuming the CRC analysis of the secondary transmission line 29 is correct.

After selecting the secondary transmission line 29, the transmitter network module 30 continues to monitor both transmission lines 28, 29. If the quality of the primary transmission line 28 recovers, the transmitter network module 30 may reactivate the primary transmission line 28 to communicate the media source programming. If the quality of the secondary transmission line 29 is determined to be insufficient as well as the primary transmission line 28, the transmitter network module 30 resorts to the next level of protection. That is, if both transmission lines 28, 29 fail, or if there is an internal failure on the station network module 24 and/or the transmitter network module 30, the transmitter network module 30 has the ability to switch the analog inputs or outputs to the auxiliary transmission medium 44. The drop-out relays on the unit are energized such that the auxiliary position is induced and the auxiliary transmission medium 44 is selected. If the station network module 24 and/or the transmitter network module 30 fail, or if the transmitter network module 30 detects an external failure condition, the drop-out relays are operated in the auxiliary position and the auxiliary transmission medium 44 is automatically connected. For example, the drop-out relays can operate in the auxiliary position when de-energized such that the auxiliary transmission medium 44 is selected. When the drop-out relays are energized, the normal position is induced and the media transmission system 10 operates as described above.

Referring now to FIG. 4, a video transmission system 10′ including a media station 12, a transmitter station 14 and a transmission medium 16 for transmitting video media programming is generally shown in accordance with an exemplary embodiment of the present invention. The video transmission system 10′ operates similarly to the media transmission system 10 of FIG. 1 described in detail above. The video media will almost always include audio; however, the audio is not explicitly shown to simplify the drawing. The video transmission system 10′ utilizes a high bandwidth transmission medium for handling the increases bandwidth required for transporting the video media 19. The high bandwidth transmission medium includes, but is not limited to T3 line, SONET, or Ethernet. The backup media programming provided from the media station 12 via the Ethernet media source 20 is backup video media programming. Accordingly, the file storage device 32 included in system of FIG. 3 is generally greater than the file storage device included in FIG. 1 since the backup video media data is of greater file size.

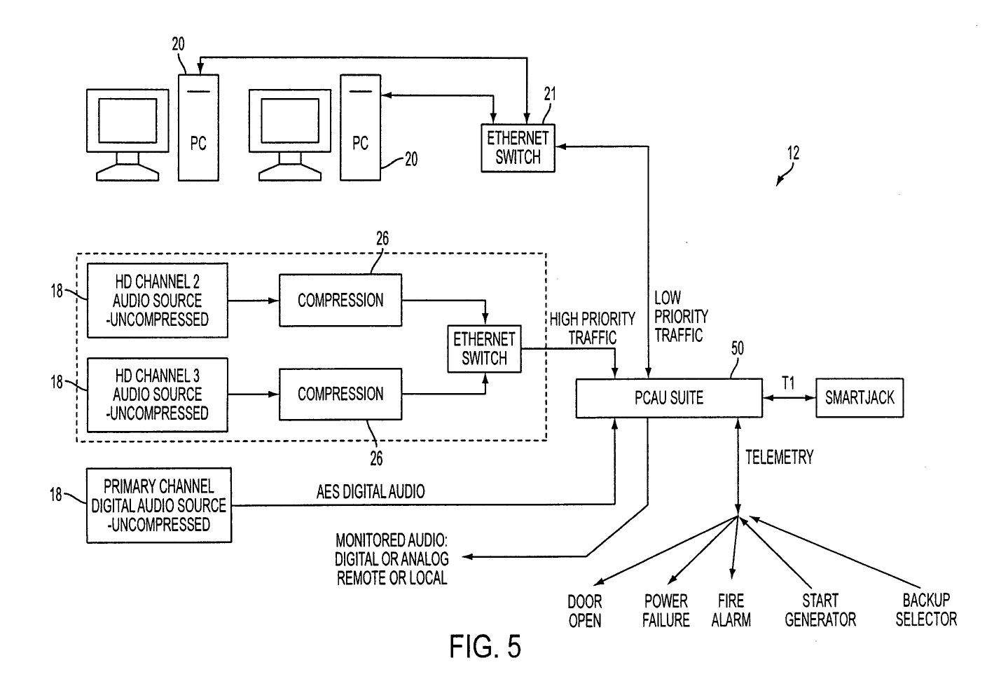

FIGS. 5-10 illustrate alternative exemplary embodiments of the present invention. For example, FIG. 5 depicts an exemplary embodiment of a digital FM media station. The digital FM media station includes a media station 12 and a transmitter station 14 that are separated from one another by several miles. The media programming is generated and stored at the media station 12, while the transmitter station 14 includes a transmitter 38 for transmitting the media programming in real-time. Multiple signal streams can be sent from the media station 12 to the transmitter station 14.

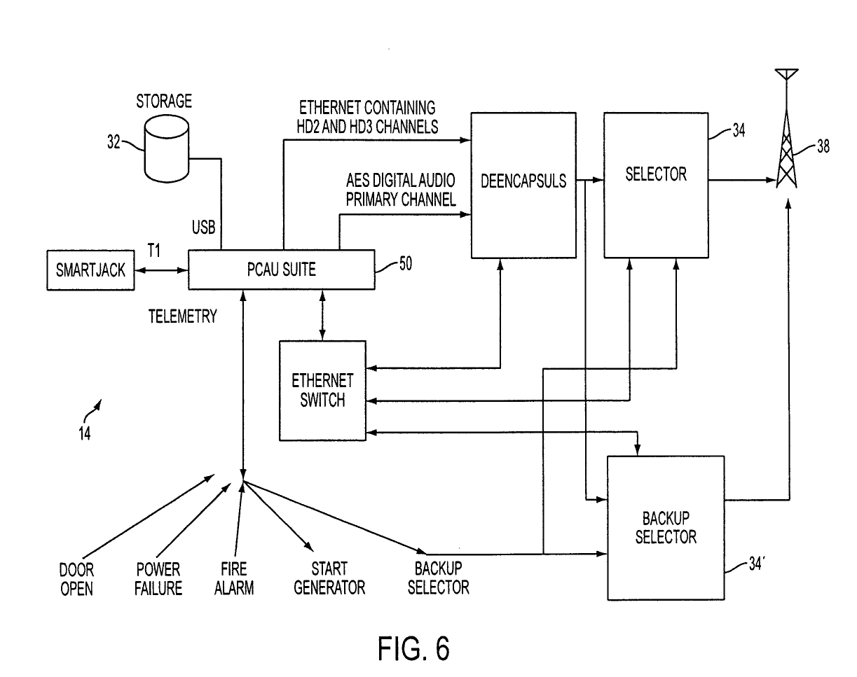

FIG. 6 depicts an exemplary embodiment of a digital FM transmitter station. The station network module 24 and/or the transmitter network module 30 allow the transport of stereo full bandwidth audio signal, with an optional data channel, over multiple timeslots of a transmission medium 16 such as a T1/E1 link. The modules 24 and 30 are program channel access units (PCAUs) that can be combined into a single device referred to as a PCAU suite 50. The PCAU suite 50 can be provided at both ends of the audio link and configured to operate as the corresponding one of the modules 24 and 30. The station network module 24 and/or the transmitter network module 30 have selectable digital/analog audio interfaces. Additionally, the station network module 24 and/or the transmitter network module 30 add an optional RBDS data channel, provide lower end-to-end delay, and add an external audio timing synchronization port. The station network module 24 and/or the transmitter network module 30 preferably pass an audio signal in both directions simultaneously.

The station network module 24 is used at the media station 12 and the transmitter network module 30 is used at the transmitter station 14. A mono or stereo audio source is connected to a transmit audio port (not shown) of the station network module 24 or one of the PCAU suites 50. The station network module 24 or the originating PCAU suite 50 encodes and/or compresses the audio signal and places it on multiple channels of the transmission medium 16. The applied audio signal may be digitally encoded in the AES3 digital format, or analog format. Further, the transmitter network module 30 or destination PCAU suite 50 decodes and/or decompresses the signal, and provides the audio signal in either AES3 digital or analog format.

As discussed above, the media transmission system 10 may include a redundant transmission medium 16 including a primary transmission line 28 and a secondary transmission line 29. The media transmission system 10 may be configured to retrieve backup media programming in the event of the station network module 24 and/or the transmitter network module 30 fails, or a failure of one of the transmission lines 28, 29.

As shown in FIG. 5 and FIG. 6, a radio station can have three program sources. The Main Program is the audio material heard on a standard audio channel, received on conventional radio receivers. HD2 and HD3 are alternate programs that are sent over the additional channels provided by HD Radio. A customer with a standard radio receiver only hears the Main Program. A customer with an HD Radio receiver can hear any of the three audio programs. Each program source has associated data. The data may include song titles, radio station identification, weather, and other low bit rate information. This data is referred to as Radio Broadcast Data System (RBDS, or just RDS) and normally is received simultaneously with the audio program. The Main Program information is frequently processed by studio equipment to normalize the audio levels, and possibly equalize it to produce some desired effect. The processed audio is passed as either a 600-ohm, balanced analog signal, or a 110-ohm balanced digital AES3 signal, to the PCAU suite 50 in FIG. 5 The PCAU suite 50 in FIG. 5 compresses the signal using Enhanced apt-X® compression, for example, to achieve a 4:1 reduction in bit rate. The compressed data is sent over multiple channels in the T1/E1 circuit 16.

Channels HD2 and HD3 are similarly processed by studio equipment. In addition, they are digitized and highly compressed. The resultant bit streams are normally provided on an Ethernet 10/100 Base-T connection. These bit streams arrive at the PCAU suite 50 in FIG. 5 and are combined with any extra customer traffic provided at the second Ethernet port. The data is sent over six of the timeslots of the T1/E1 circuit. HD2 and HD3 traffic has priority over other Ethernet traffic. The prioritization is accomplished by connecting the HD2 and HD3 traffic via port 0, and low priority traffic via port 1. The RBDS data is presented to the PCAU suite 50 as a 9600 bps data stream in RS232 format. This data is multiplexed with the compressed audio information and sent to the far end (e.g., PCAU suite 50 in FIG. 6) over the dedicated Main Program timeslots.

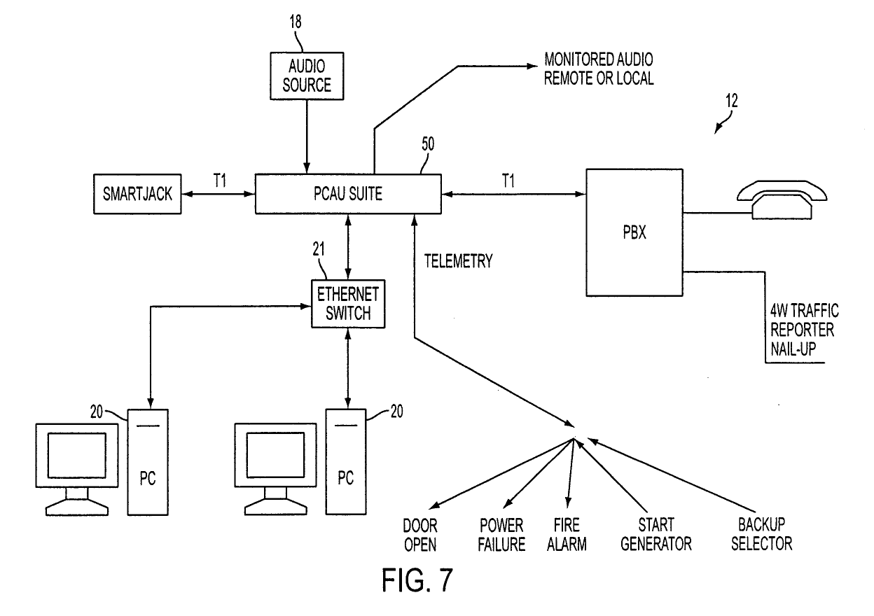

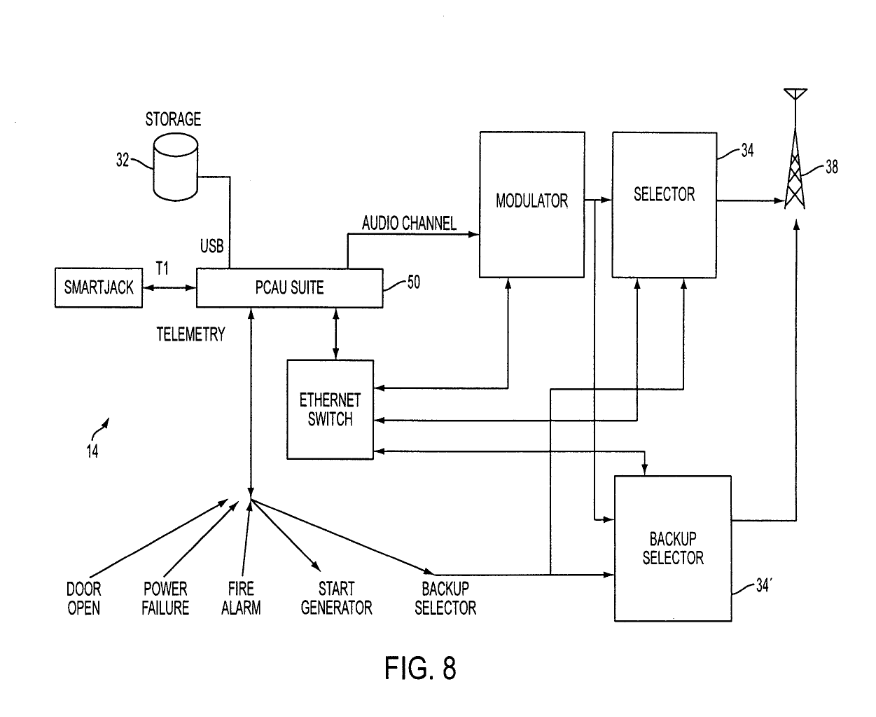

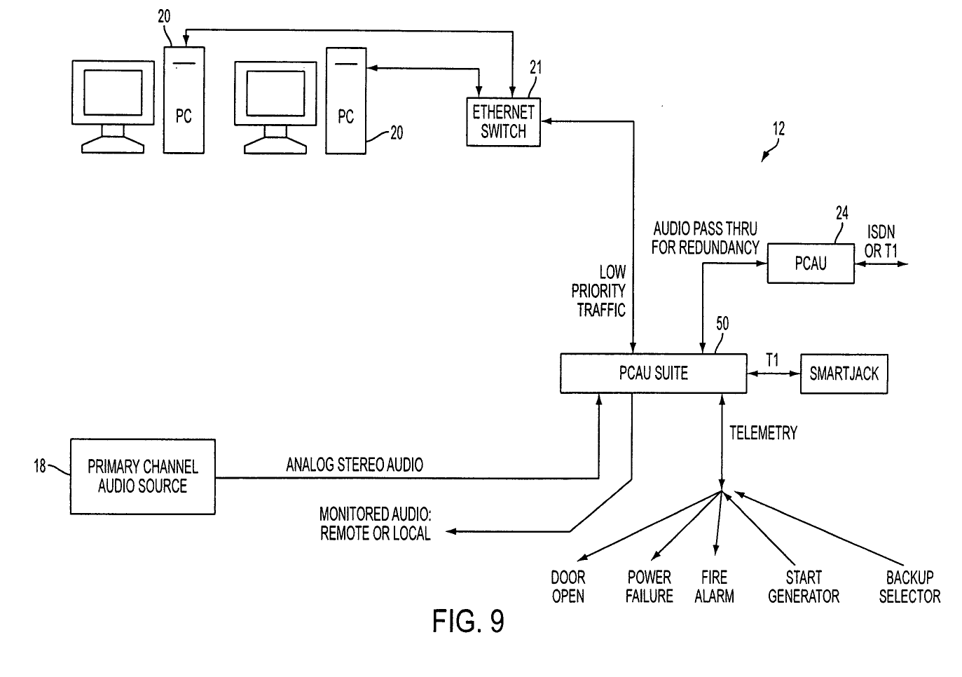

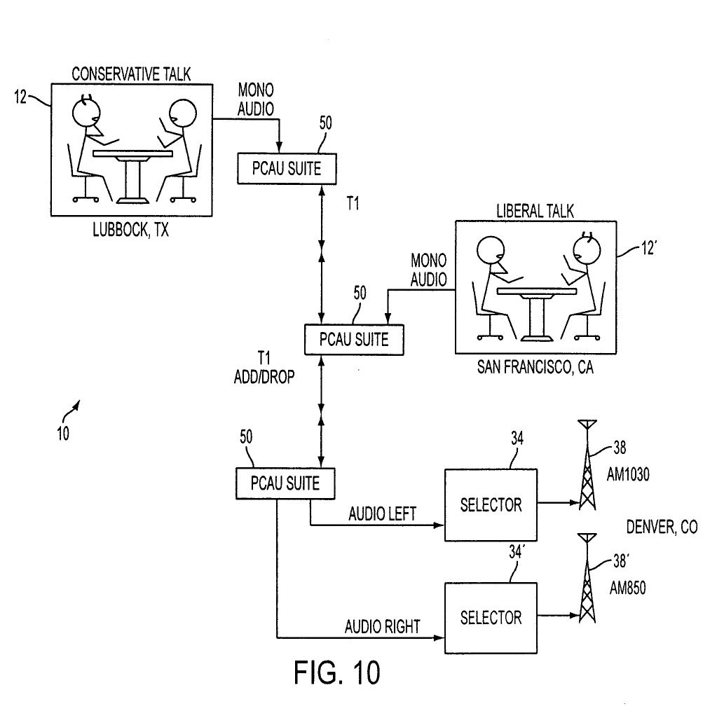

FIG. 7 depicts an exemplary embodiment of an AM media station. Specifically, the lower audio bandwidth requirement allows remaining factional T1 resource to be used for other purposes such as PBX. FIG. 8 depicts an exemplary embodiment of an AM transmitter station, which is similar to the FM transmitter station shown in FIG. 6. FIG. 9 depicts an alternative exemplary embodiment of a media transmission system 10 showing the operation of a transmitter station 14 if a connection fault between the media station 12 and the transmitter station 14 occurs. Lastly, FIG. 10 depicts an exemplary embodiment of a media transmission system 10 including two AM stations with the same ownership, but separate media programming provided from two different locations.

Although exemplary embodiments of the present invention have been disclosed for illustrative purposes, those skilled in the art will appreciate that various modifications, additions, and substitutions are possible, without departing from the scope of the present invention. Therefore, the present invention is not limited to the above-described embodiments, but is defined by the following claims, along with their full scope of equivalents.

1. A media transmission system comprising:
a media programming source input for receiving a source media signal including media programming;
a compression module for compressing the source media signal and for outputting a compressed source media signal;
an Ethernet media source input for receiving an Ethernet media signal including backup media programming being different than the media programming;
a station network module in electrical communication with the media programming source input and the Ethernet media source input for encapsulating each of the media signal and the Ethernet media signal and for multiplexing each of the media signal and the Ethernet signal and outputting a data signal comprising the media signal and the Ethernet signal;
a transmitter network module for receiving the data signal and for demultiplexing the data signal to obtain the encapsulated source media signal and the encapsulated Ethernet media signal and for de-encapsulating the encapsulated media signal to obtain the source media signal and for de-encapsulating the encapsulated Ethernet media signal to obtain the Ethernet media signal;
a transmission medium in electrical communication with the station network module and the transmitter network module for communicating signals therebetween;
a decompression module for decompressing the compressed source media signal to obtain the source media signal;
a storage device for storing the backup media programming based on the Ethernet media signal;
a selection module selectively operable in a source mode for delivering the source media signal and in a backup mode for delivering a backup media signal;
a transmitter for transmitting at least one of the transmission signal and the backup media signal;
a controller in electrical communication with the transmitter network module and the selection module for selecting the source mode to deliver the compressed source media signal to the decompression module and for delivering Ethernet media signal to the storage device and for detecting a fault on the transmission medium;
the controller being in electrical communication with the storage device for selecting the backup mode of the selection module and for retrieving the backup media programming and for generating the backup media signal including the backup media programming in response to detecting a fault on the transmission medium;
the fault including at least one of the communication network being disconnected from the station network module and the transmitter network module, and an error in a data signal, and an error in the source media signal;
wherein the transmitter transmits the source media signal in response to the selection module operating in the transmission mode and transmits the backup media signal in response to the selection module operating in the backup mode, and
wherein backup programming is stored in the storage device while simultaneously transmitting the source media signal via the transmitter.

2. A media transmission system comprising:
a media programming source input for receiving a source media signal including media programming;
an Ethernet media source input for receiving an Ethernet media signal including backup media programming;
a station network module in electrical communication with the media programming source input and the Ethernet media source input for multiplexing each of the source media signal and the Ethernet signal and for outputting a data signal comprising the media signal and the Ethernet signal to the transmission medium;
a transmitter network module in electrical communication with the transmission medium for receiving the data signal and for demultiplexing the data signal to obtain the source media signal and the Ethernet media signal;
a transmission medium for communicating the data signal from the station network module to the transmitter network module;
a storage device for storing the backup media programming based on the Ethernet media signal;
a selection module selectively operable in a source mode for delivering the source media signal and a backup mode for delivering a backup media signal;
a controller in electrical communication with the transmitter network module and the selection module for selecting the source mode to deliver the source media signal to the selection module and for delivering the Ethernet media signal to the storage device and for detecting a fault on the transmission medium;
the controller being in electrical communication with the storage device for selecting the backup mode of the selection module and for retrieving the backup media programming and for generating the backup media signal including the backup media programming in response to detecting a fault on the transmission medium; and
a transmitter for transmitting at least one of the source media signal and the backup media signal;
wherein the transmitter transmits the transmission signal in response to the selection module operating in the source mode and transmits the backup signal in response to the selection module operating in the backup mode.

3. The media transmission system as set forth in claim 2 wherein backup programming is stored in the storage device while simultaneously transmitting the source media signal via the transmitter.

4. The media transmission system as set forth in claim 2 wherein the backup media programming generated by the Ethernet media source is different than the media programming generated by the media programming source.

5. The media transmission system as set forth in claim 4 wherein the transmission medium is a redundant transmission medium comprising a primary transmission line and a secondary transmission line.

6. The media transmission system as set forth in claim 5 wherein the transmitter module determines the quality of data communicated over each of the primary transmission line and the secondary transmission line.

7. The media transmission system as set forth in claim 6 wherein the transmitter module selects one of the primary transmission line and the secondary transmission line based on the quality of data.

8. The media transmission system as set forth in claim 2 wherein the station network module further comprises an encapsulation module for encapsulating the source media signal to generate an encapsulated source media signal and for encapsulating the Ethernet media signal to generate an encapsulated Ethernet media signal.

9. The media transmission system as set forth in claim 8 wherein the transmitter network module further comprises a de-encapsulation module for de-encapsulating the encapsulated source media signal to obtain the source media signal and for de-encapsulating the encapsulated Ethernet media signal to obtain the Ethernet media signal.

10. The media transmission system as set forth in claim 2 further comprising a compression module in electrical communication with the station network module for compressing the source media signal.

11. The media transmission system as set forth in claim 10 further comprising a decompression module in electrical communication with the transmitter network module for decompressing the source media signal.

12. The media transmission system as set forth in claim 2 further comprising a first switch-to-protect module and a second switch-to-protect module and an auxiliary transmission medium in electrical communication with the first switch-to-protect module and the second switch-to-protect module, wherein at least one drop-out relay of the first switch-to-protect module operates in the normal position to select the circuit path between the media programming source input and the station network module and operates in an auxiliary position to select a circuit path between the media programming source input and the auxiliary transmission medium.

13. The media transmission system as set forth in claim 2 further comprising a first switch-to-protect module and a second switch-to-protect module and an auxiliary transmission medium in electrical communication with the first switch-to-protect module and the second switch-to-protect module, wherein at least one drop-out relay of the second switch-to-protect module operates in the normal position to select the circuit path between the transmitter and the transmitter network module and operates in the auxiliary position to select a circuit path between the auxiliary transmission medium and the transmitter.

14. The media transmission system as set forth in claim 2 wherein the fault comprises at least one of the communication network being disconnected from the station network module and the transmitter network module, and an error in the data signal, and an error in the source media signal.

15. A method for transmitting backup programming media in a transmitter station being connected to a remote media station via a transmission medium, the method comprising:
generating a source media signal including media programming via a media programming source located at the media station;
generating an Ethernet media signal including backup media programming being different the media programming via an Ethernet programming source located a the media station;
receiving the source media signal at the transmitter station and transmitting the media programming based on the source media signal;
receiving the Ethernet media signal at the transmitter station and storing the backup media programming in a storage device based on the Ethernet media signal;
detecting at least one of a fault on the transmission medium and an input initializing the backup media programming;
retrieving the stored backup media programming and generating a backup media signal including the backup media programming; and
transmitting backup media programming based on the backup media signal.

16. The method as set forth in claim 15 further comprising storing the backup media programming while simultaneously transmitting the source media signal.

17. The method as set forth claim 15 further comprising multiplexing the source media signal and the Ethernet media signal for outputting a data signal to the transmitter station.

18. The method as set forth in claim 17 further comprising demultiplexing the data signal received by the transmitter station for obtaining the source media signal and the Ethernet media signal.

19. The method as set forth in claim 18 further comprising compressing the source media signal prior to multiplexing the source media signal with the Ethernet media signal.

20. The method as set forth in claim 19 further comprising decompressing the source media signal after de-multiplexing the data signal.

21. The method as set forth in claim 17 wherein detecting a fault on the transmission medium comprises at least one of detecting the communication network being disconnected from the media station and the transmitter station, and detecting an error in the data signal, and an error in the source media signal.

22. The method as set forth in claim 21 wherein the step of detecting an error in the data signal is based on a Cyclic Redundancy Check (CRC) included with the data signal.

23. A transmitter system for generating backup programming in a media transmission system comprising:
a transmitter network module in electrical communication with a transmission medium for receiving a source media signal including media programming and an Ethernet media signal including backup media programming being difference from the media programming;
a storage device for storing the backup media programming based on the Ethernet media signal;
a selection module selectively operable in a source mode for delivering the source media signal and a backup mode for delivering a backup media signal;
a controller in electrical communication with the transmitter network module and the selection module for selecting the source mode to deliver the source media signal to the selection module and for delivering the Ethernet media signal to the storage device and for detecting a fault on the transmission medium;
the controller being in electrical communication with the storage device for selecting the backup mode of the selection module and for retrieving the backup media programming and for generating the backup media signal including the backup media programming in response to detecting a fault on the transmission medium; and
a transmitter for transmitting one of the source media signal or the backup media signal;
wherein the transmitter transmits the transmission signal in response to the selection module operating in the source mode and transmits the backup signal in response to the selection module operating in the backup mode.

24. The transmitter system as set forth in claim 23 wherein backup programming is stored in the storage device while simultaneously transmitting the source media signal via the transmitter.

25. The transmitter system as set forth in claim 23 wherein the transmitter network module receives a multiplexed data signal including the source media signal and the Ethernet media signal.

26. The transmitter system as set forth in claim 25 further comprising a demultiplexer for demultiplexing the data signal to obtain the source media signal and the Ethernet media signal.

27. The transmitter system as set forth in claim 26 further comprising a decompression module in electrical communication with the transmitter network module and the transmitter for decompressing the source media signal.

28. The transmitter system as set forth in claim 23 further comprising a switch-to-protect module selectively providing a circuit path between the transmitter network module and the transmitter.

29. The transmitter system as set forth in claim 28 wherein the switch-to-protect module includes at least one drop-out relay selectively operable in a normal position and an auxiliary position.

30. The transmitter system as set forth in claim 29 wherein the normal position of the drop-out relay selects a circuit path between the transmitter network module and the transmitter module and the auxiliary position selects a circuit path between an auxiliary transmission line and the transmitter.

31. The transmitter system as set forth in claim 25 wherein detecting a fault on the transmission medium comprises at least one of detecting the communication network being disconnected from the media station and the transmitter station, and detecting an error in the data signal, and an error in the source media signal.

32. The transmitter system as set forth in claim 31 wherein the step of detecting an error in the data signal is based on a Cyclic Redundancy Check (CRC) included with the data signal.

33. The media transmission system as set forth in claim 2 further comprising a station controller in electrical communication with the Ethernet media input for outputting at least one user selection signal for selecting one of the source mode or the backup mode of the selection module.
